(19) United States
(12) Patent Application Publication
(10) Pub. No.: US 2002/0056450 A1
(43) Pub. Date: May 16, 2002

(54) Anti-fogging mask

(76) Inventor: Kun Woo Lee, Seoul (KR)

Correspondence Address: Kun Woo Lee, #101-1101 Sky Sang Yong, Apt. 1014 Jung Lung-1 Dong, Sung-Buk-Ku, Seoul, KR

(21) Appl. No.: 09/952,619

(22) Filed: Sep. 11, 2001

(30) Foreign Application Priority Data
Nov. 10, 2000 (KR) 20-0221064

(51) Int. Cl. A62B 18/08; A62B 7/10; A62B 23/02

(52) U.S. Cl. 128/201.15; 128/206.13; 128/206.12

(57) ABSTRACT

This invention is an Anti-Fog Mask which is designed to prevent glasses from fogging due to the moist breath from the mouth and nose of the users of glasses in the winter, by a specially designed system that will closely contact the mask with the nose of the user. This particular mask is effective in preventing the moist breath coming out through the upper part of the mask, and its structure is simple and cheap to produce.

### RELATED APPLICATION

This application claims the benefit of patent application number 20-0221064, filed Nov. 10, 2000, in the Korea Intellectual Property Office (“KIPO”) for an invention having the above-stated title. As-filed KIPO patent application number 20-0221064 (“Foreign Application”) is hereby incorporated herein by reference. The English language translation of the Foreign Application is the remainder of this document, and the Translator's Declaration applies to the remainder of this document.

### BACKGROUND OF THE INVENTION

1. Field Of The Invention

This invention relates to an anti-fogging mask which is designed to prevent glasses from fogging due to the moist breath from the mouth and nose of the users of glasses in the winter, by specially designed system that will keep in close contact the mask with the nose of the user.

2. Description of Related Art

As an example of an anti-fogging mask, Korea Pat. No. 195919 (utility model) is an anti-fogging mask that is used by people who ride motorcycles or bicycles in the winter. This patent prevents fogging on the front part of the helmet caused by moist breath from the mouth and nose of the user, by using a pad that prevents the moist breath from rising and by changing the moist breath into water and letting it go down to the lower part of the mask.

Notwithstanding the present application of this patent, people who use this patent do not feel comfortable because of the anti-evaporation pad that is attached to the upper part of the mask. Also, this pad is not washable due to the complicated structure of the mask so that it is not sanitary. This patent cannot be perfectly adjusted to the nose of the user, and because it covers the nose with a pad, moist breath may come out of the mask and go upward. Another problem with this patent is that it is made to be fitted for a motorcycle helmet so that its use is limited to people who are riding motorcycles. Accordingly, a primary objective of this invention is to provide an improved anti-fogging mask by adding a washable and detachable breath-blocking park to a regular form of a mask. This invention perfectly seals the nose and covers the upper part of the face above the mask. It has broad applications in that it can be used not only by people who wear glasses but also by those who ride motorcycles or those who work in cold storage warehouses. Another objective of this invention is to provide a cheaper anti-fogging mask through a mass production system that is possible due to its simple structure.

### SUMMARY OF THE INVENTION

To achieve the foregoing and other objectives, the present invention is generally directed to an improved anti-fogging mask. In accordance with the objectives of the invention, a pocket is provided at the end of the invention, a breath-blocking material which is made from a soft material is inserted inside the said pocket and a wire or a form-memorizing alloy is inserted inside the said breath-blocking material so that the upper part of the invention may be kept in close contact with the inside the breath-blocking part.

### BRIEF DESCRIPTION OF THE DRAWINGS

FIG. 1 is an overview of the invention.

FIG. 2 is a detailed drawing of part A of the invention as shown in FIG. 1.

FIG. 3 is a detailed drawing of part C-C′ of the invention as shown in FIG. 2.

FIG. 4 is another overview of the invention.

FIG. 5 is a section of part B-B′ of the invention as shown in FIG. 4.

FIG. 6 shows the invention being worn by the user.

### DETAILED DESCRIPTION OF THE PREFERRED EMBODIMENT

The functions and structure of this invention according to the drawings is as the following.

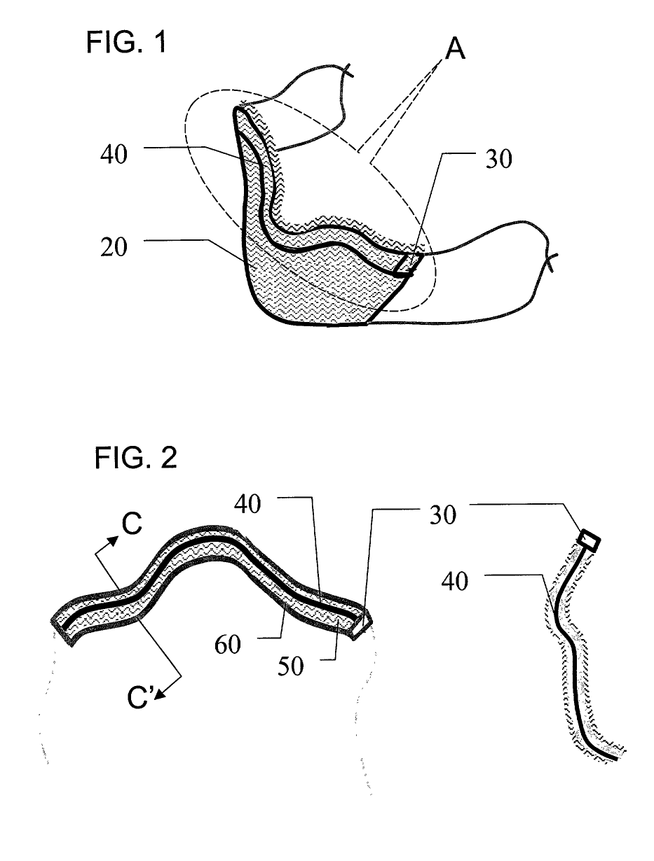

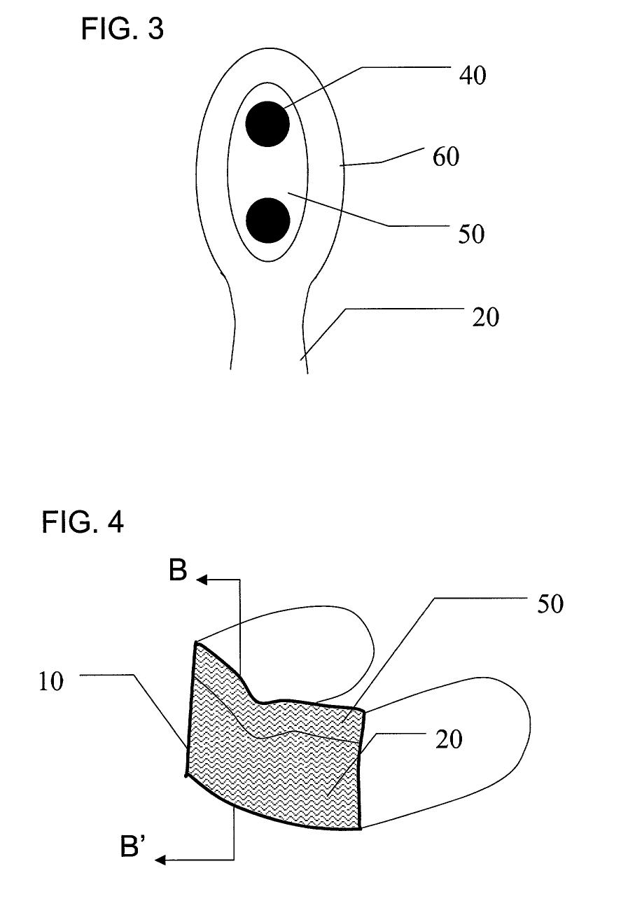

FIG. 1 is an overview of the invention, FIG. 2 is a detailed drawing of part A of the invention as shown in FIG. 1, FIG. 3 is a detailed drawing of part C-C′ of the invention as shown in FIG. 2,

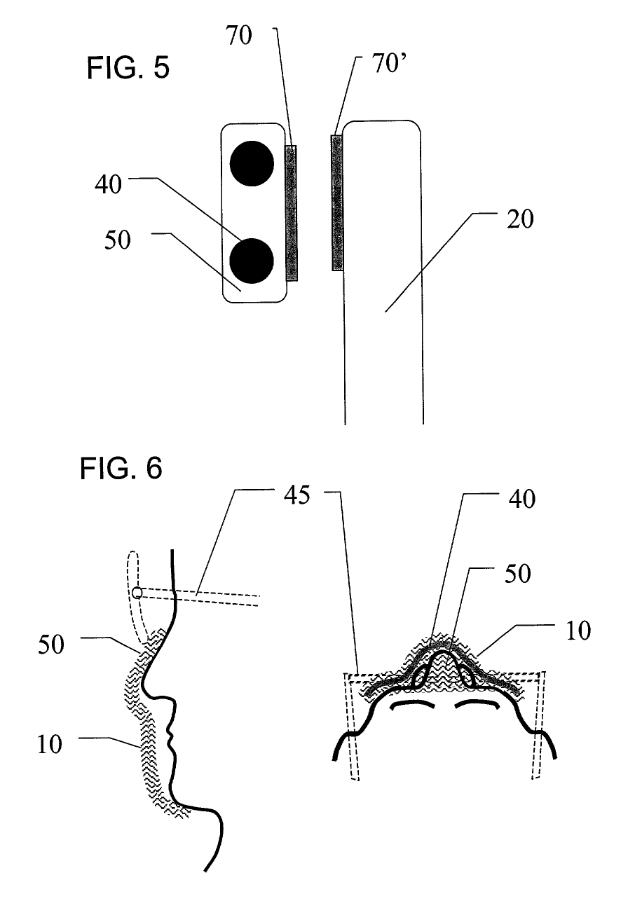

FIG. 4 is another overview of the invention. FIG. 5 is a section of part B-B′ of the invention as shown in FIG. 4 and FIG. 6 shows the invention being worn by the user.

Referring now to FIGS. 1 and 3, the invention comprises the body (20) of the invention with a pocket (60) on its top, a detachable breath-blocking part (50) that is attached to the said pocket (60) and a wire (40) inserted in and fixed to the breath-blocking part (50).

The said breath-blocking part (50) is made from a flexible material such as rubber so that the upper part of the invention may be kept in close contact with the nose and the upper part of the face.

Both ends of the said pocket (60) are tightly sealed so that the breath-blocking part (50) may not come out of the invention. An insert groove (30) is provided inside the area that secures one end of the said pocket (60) so that the breath-blocking part (50) may be easily detachable for washing. Either by deeply or shallowly inserting the said breath-blocking part (50) and pocket (60) in order to elongate the invention for a better fit, the said breath-blocking part (50) and pocket (60) may have various shapes.

A wire (40) which is coated with plastic or rubber or which is made of form-memorizing alloy is inserted inside the breath-blocking part (50) and its shape is maintained unless it is subjected to an outside force. The said wire (40) can be one or more.

Referring now to FIGS. 4 and 5, the said breath-blocking part (50), which is detachable, is on the upper part of the body (20) of the invention. Velcro (70, 70′) is attached to the said detachable breath-blocking part (50) so that it can be detachable to the upper end of the body (20) of the invention and a wire (40) is inserted into the said detachable breath-blocking part (50).

The said Velcro (70, 70′) is attached to the upper part of the body (20) of the invention and the Velcro's contact area of the detachable breath-blocking part (50) so that it can be detachable to the upper part of the body (20) of the invention.

FIG. 6 illustrates the structure of the invention. The detachable breath-blocking part (50) and wire (40) are in close contact with the upper part of the body (20) of the invention so that there is no gap between the mask and the nose and the moist breath cannot go up to the glasses (45) but is absorbed by the body (20) of the mask or falls down to the lower part of the body (20) of the invention without fogging up the glasses (45).

The shape of this invention is not limited to the above description but may vary within the scope of the claims of this invention, and such variation of the shape is within the scope of the claims of this invention.

I claim:

1. An anti-fogging mask, comprising:
the body of the invention;
a pocket attached to the upper end of the body;
a detachable, breath-blocking parts inserted into the said pocket;
a wire, coated with plastic or rubber which is made of form-memorizing alloy, which helps the upper part of the body of the invention remain closely in contact with the nose.

2. An anti-fogging mask as in claim 1, wherein both ends of the said pocket are sealed and an insert groove is provided to enhance the detachability of the breath-blocking part.

3. An anti-fogging mask as in claim 2, wherein Velcro is attached to the upper part of the body of the invention and to the Velcro's contacting area of the breath-blocking part so that the said breath-blocking part may be detachable to the upper part of the body.
